(19) United States
(12) Patent Application Publication
(10) Pub. No.: US 2025/0271557 A1
(43) Pub. Date: Aug. 28, 2025

(54) PROXIMITY SENSOR SYSTEM AND METHOD OF OPERATING A PROXIMITY SENSOR SYSTEM

(71) Applicant: ams-OSRAM AG, Premstaetten (AT)

(72) Inventors: Bernhard GREIMEL-LÄNGAUER, Hofstätten an der Raab (AT); Herbert LENHARD, Graz (AT)

(21) Appl. No.: 18/860,944

(22) PCT Filed: Feb. 2, 2023
(86) PCT No.: PCT/EP2023/052616

§ 371 Date: Oct. 28, 2024

(30) Foreign Application Priority Data
Apr. 28, 2022 (DE) 10 2022 110 406.0

(51) Int. Cl. G01S 7/487; G01S 17/04

(52) U.S. Cl. CPC G01S 7/4876; G01S 17/04

(57) ABSTRACT

A proximity sensor system includes a light emitter and a driver circuit configured to drive the light emitter such that the light emitter emits a sequence of pulses towards an external target. The proximity sensory system also includes a light detector operable to generate a time-dependent sensor signal which is indicative of light reflected off of the external target. The proximity sensory system further includes a processing unit operable to convert the sensor signal to frequency-dependent converted sensor signal, wherein the converted sensor signal is a representation of the sensor signal in the frequency domain.

### DESCRIPTION

This disclosure relates to a proximity sensor system and to a method of operating a proximity sensor system.

### BACKGROUND OF THE DISCLOSURE

Proximity sensors find various applications, e.g. proximity and presence detection for Automotive, Industry and Consumer market. Proximity detection sensors emit and measure reflected light, such as infrared (IR) energy, to detect the presence of an object or person. For example, the devices include an integrated LED driver and, in some devices, an integrated LED. The proximity detection devices may provide programmable LED drive currents and pulse repetitions. Proximity sensors typically operate under ambient light conditions. Proximity detection circuitry compensates for ambient light, allowing it to operate in environments ranging from bright sunlight to dark rooms. Existing proximity solutions are able to detect DC light conditions but to date remain highly sensitive for AC light disturbances.

FIG. 8A shows an example embodiment of a prior art proximity sensor system. In existing solutions data samples are taken with ambient light and with ambient light plus reflected light and subtracted. The subtraction gives than direct the proximity data output. The example system shown in the drawing comprises a light emitter LE and a light detector LD, which are arranged close to each other (for better illustration a module or housing is not depicted). In operation, the light emitter sends out pulses of light, which eventually strike an external target ET, placed in a distance to the proximity sensor system. The amount of reflected light is a measure of distance to the target. However, ambient light may disturb the reflected light from emitter.

FIG. 8B shows an example signal scheme of the prior art proximity sensor system. The upper graph shows an emitter pulse as a function of time. The graph in the middle shows a sensor signal as a function of time. The sensor signal resemble the emitter pulse, which is due to the light being reflected at the external target ET. Furthermore, the sensor signal is offset by an amount due to ambient light. The bottom graph shows an example proximity measurement cycle.

The cycle comprises windows W1, W2 and W3. Each window indicated a time interval during which the detector signal is integrated. During the first window W1 the sensor signal amounts to a first value SW1, e.g. in terms of counts. The first value SW1 is taken during a time where no pulse is detected, i.e. ambient light only. During the second window W2 the sensor signal amounts to a second value SW2. The second value SW2 is taken during a time where a pulse is detected, i.e. has contributions of reflected light and ambient light. The (optional) third value SW3 is again taken during a time where no pulse is detected, i.e. ambient light only.

The sensor signal values integrated during windows W1, W2 and W3 allow to determine an amount of ambient light. For example, a distance information can be extracted as SW2-SW1, which directly subtracts a contribution of ambient light. This calculation assumes that the ambient light stays constant, e.g. during following pulses (DC ambient light). A first order AC ambient light suppression may account for some degree of changes in ambient light by averaging multiple ambient light values, e.g. SW1 and SW3. For example, distance information can be extracted as SW2−(SW1+SW3)/2.

Nonetheless, while existing proximity sensing solutions to date have a certain preset phase and support multiple pulses for a single measurement, they remain in the time domain and are highly sensitive for AC light disturbances.

It is therefore an object to provide an improved concept for proximity sensing which is less prone to ambient light.

This object is achieved by the subject-matter of the independent claims. Further implementations and embodiments are the subject-matter of the dependent claims.

### SUMMARY OF THE DISCLOSURE

The following relates to an improved concept in the field of optical proximity sensing. One aspect suggests a proximity solution in the frequency domain. A proximity sensor signal can be measured and transformed by using a frequency transformation, such as fast Fourier transformation, FFT for short, or Goertzel FFT. A proximity signal can be measured in a separate frequency bin, while ambient light may be separated into a different disturbed bin. By doing a frequency domain analysis of the ambient light in advance the disturbed frequency bins can be detected and a different pulse frequency can be used for the measurement.

In at least one embodiment, a proximity sensor system comprises a light emitter, a driver circuit, a light detector and a processing unit. The light emitter is operable to emit light with a desired wavelength.

In operation, the driver circuit operates the light emitter such that a sequence of pulses is emitted by the light emitter and directed towards an external target. Eventually, the emitted light is reflected off of the external target and returns back to the proximity sensor system. The light detector is operable to generate a time-dependent sensor signal from the returned reflected light, i.e. the sensor signal is indicative of light reflected off of the external target (ET), and typically resembles the sequence of pulses. The processing unit is operable to convert the sensor signal to frequency-dependent converted sensor signal, wherein the converted sensor signal is a representation of the sensor signal in the frequency domain.

With the improved concept, multiple samples can be captured, according to the sequence of emitted pulses, which depends on time. The sensor signal of received reflected pulses is post processed in the frequency domain. In the frequency domain, contributions of alternating ambient light are apparent as they typically occur with defined frequencies. Thus, after the frequency transform the so converted sensor signal can be analyzed and ambient light contributions can be accounted for.

The term “light” denotes electromagnetic radiation from the electromagnetic spectrum having wavelengths in the range of 400 to 700 nm (visual light) as well as the infrared (with longer wavelengths) and the ultraviolet (with shorter wavelengths). For example, the light emitter may emit light in the infrared. Ambient may be distinguished using the terms “AC ambient light” and “DC ambient light”. For example, ambient light may at least during a sampling window be constant in intensity. In analogy to direct current, this condition is reflected by the term “DC”. Some ambient light, however, may be alternating, at least during a sampling window, with a constant or even changing frequency. In analogy to alternating current, this condition is reflected by the term “AC”.

In at least one embodiment, the processing unit is operable to conduct the procedural steps of a method of operating the proximity sensor system discussed herein. This includes at least the step of converting the sensor signal to the frequency-dependent converted sensor signal, which is a representation of the sensor signal in the frequency domain.

In at least one embodiment, the processing unit is operable to sample the time-dependent sensor signal into a sampled sensor signal and convert the sampled sensor signal into the converted sensor signal. The sampling determines samples, which form a discrete subset of the sensor signal. For example, the samples represent an intensity value in counts, or any other convenient unit. The sampled sensor signal can be considered a representation of the generated sensor signal and, thus, fulfills the Nyquist criterion, i.e. the sampled sensor signal resembles the sensor signal and allows to extract the same parameters, including distance information, for example. The sampled sensor signal provides a mathematical basis to apply frequency transform operations, such as FFT.

In at least one embodiment, the processing unit is operable to sample the time-dependent sensor signal by means of coherent sampling. Coherent sampling describes the sampling of a periodic signal (here: sensor signal including a sequence of pulses), where an integer number of its cycles fit into a predefined sampling window. The sensor signal in the sampling window is sampled, i.e. an integer number of signal values are recorded as samples, which, in turn, are representative of the sensor signal in the sampling window. As a lower minimum a number of samples are recorded that fulfill the Nyquist criterion. Preferably, however, 2ⁿ coherent samples are recorded, wherein n denotes an integer number. The series of samples forms the sampled sensor signal, which forms the domain for the frequency transform function or algorithm, for example. The parameteter n can be set to any value, which meets the requirements of a desired application.

In at least one embodiment, the processing unit is operable to convert the sensor signal by means of a Fast Fourier Transformation or a Goertzel Fast Fourier Transformation. FFT provides a computationally fast and cheap way to conduct the conversion of the sensor signal into the frequency domain. For example, the processing unit may be integrated together with other components such as the driver circuit and light detector, and even the light emitter, to perform the FFT on-chip in a compact proximity sensor module. The Goertzel FFT allows to analyze only one selectable frequency component from a discrete signal, i.e. sampled sensor signal, at a time. For computing a small number of selected frequency components, it is more numerically efficient than the generic FFT.

In at least one embodiment, the processing unit is operable to group samples of the converted sensor signal into a number of frequency bins. Furthermore, the processing unit determines a proximity event and/or distance information associated with the external target based on samples of one or more frequency bins. A frequency bin may be associated with a single frequency or a range of frequencies. A number of samples collected in a same frequency bin provides a measure of the sensor signal at the corresponding frequency, or range of frequencies.

Typically, Ac ambient light has a defined frequency or a range of such frequencies. Thus, ambient light may populate only certain frequency bins. The sequence of emitted pulses, however, also has a defined frequency, denoted proximity pulse frequency, which may differ from the ambient light frequency or frequencies. This way, it may be possible to distinguish the contribution of ambient light simply by choosing the frequency bin which is associated with the proximity pulse frequency. By this choice, the contribution of ambient light can be accounted for or even be neglected.

In at least one embodiment, the processing unit is operable to choose a frequency bin from the number of frequency bins. Proximity event and/or distance information associated with the external target is determined based on samples from the chosen frequency bin only.

The actual choice can be fixed, i.e. the chosen frequency bin which is used for further processing of proximity event and/or distance information associated with the external target can be set by proximity pulse frequency. Alternatively, the choice can be done based on a defined criterion, such as previous or assumed knowledge of the system, e.g. disturbance due to AC ambient light can be expected to occur only at certain frequencies. In at least one embodiment, the processing unit is operable to determine a disturbance value of one or more frequency bins. The disturbance value is representative of samples associated to a frequency bin, respectively. A frequency bin is chosen which meets a disturbance criterion. Then, the processing unit adjusts a proximity pulse frequency of the sequence of pulses to a value of the chosen frequency bin. The driver circuit is adjusted to drive the light emitter to emit the sequence of pulses towards an external target with pulses having the adjusted proximity pulse frequency.

The disturbance value, or disturbance, provides a measure to make an informed choice of the frequency bin used for further processing. For example, the disturbance value may indicate that a frequency bin is populated by ambient light contribution and, thus, may not be suitable for proximity sensing. The disturbance criterion may involve a threshold comparison in order to determine an amount of ambient light contribution. If a bin is too populated, then the processing unit adjusts a proximity pulse frequency to a value of a frequency bin which is less populated. This way, a frequency bin can be chosen which is less affected by ambient light.

In at least one embodiment, the proximity sensor system further comprises an ambient light sensor. This way, a parallel sensing of ambient light can be conducted. The ambient light sensor can provide a measure of ambient light, e.g. DC ambient light, which can be used to correct the sensor signal of the proximity sensor. For example, a dc offset can be subtracted.

In at least one embodiment, the processing unit, the light detector, the driver circuit and/or the light emitter are integrated into a common integrated circuit. For example, these components are integrated using CMOS technology.

Furthermore, a method of operating a proximity sensor system is suggested. The method involves, using a light emitter, emitting of a sequence of pulses towards an external target. Using a light detector, a time-dependent sensor signal is generated, which is indicative of light reflected off of the external target. Using a processing unit, converting the sensor signal is converted into a representation in the frequency domain.

In at least one embodiment, the time-dependent sensor signal is sampled into a sampled sensor signal, e.g. by coherent sampling, and the sampled sensor signal is converted into the converted sensor signal.

In at least one embodiment, the sensor signal is converted by means of a Fast Fourier Transformation or a Goertzel Fast Fourier Transformation.

In at least one embodiment, samples of the converted sensor signal are grouped into a number of frequency bins. Then, a proximity event and/or distance information associated with the external target is determined based on samples of one or more frequency bins.

In at least one embodiment, a frequency bin is chosen from the number of frequency bins. The proximity event and/or distance information associated with the external target is determined based on samples from the chosen frequency bin only.

In at least one embodiment, a disturbance value of frequency bins is determined, wherein the disturbance value is representative of samples associated to a frequency bin, respectively. A frequency bin is chosen which meets a disturbance criterion. A proximity pulse frequency of the sequence of pulses to a value of the chosen frequency bin is adjusted. The light emitter is driven to emit the sequence of pulses towards an external target with pulses having the adjusted proximity pulse frequency.

Further embodiments of the method become apparent to the skilled reader from the aforementioned embodiments of the proximity sensor system, and vice-versa.

### BRIEF DESCRIPTION OF THE DRAWINGS

The following description of figures may further illustrate and explain aspects of the proximity sensor arrangement and to a method of operating a proximity sensor arrangement. Components and parts that are functionally identical or have an identical effect are denoted by identical reference symbols. Identical or effectively identical components and parts might be described only with respect to the figures where they occur first. Their description is not necessarily repeated in successive figures.

In the figures:

FIG. 1 shows an example embodiment of a proximity sensor system,

FIG. 2 shows an example signal scheme of a proximity sensor system,

FIG. 3 shows an example flowchart of a method of operating a proximity sensor system,

FIG. 4 shows another example flowchart of a method of operating a proximity sensor system,

FIG. 5 shows an example sensor signal with contribution of alternating ambient light,

FIG. 6 shows an example sensor signal transformed into the frequency domain,

FIG. 7 shows another example sensor signal transformed into the frequency domain,

FIG. 8A shows an example embodiment of a prior art proximity sensor system, and

FIG. 8B shows an example signal scheme of the prior art proximity sensor system.

### DETAILED DESCRIPTION

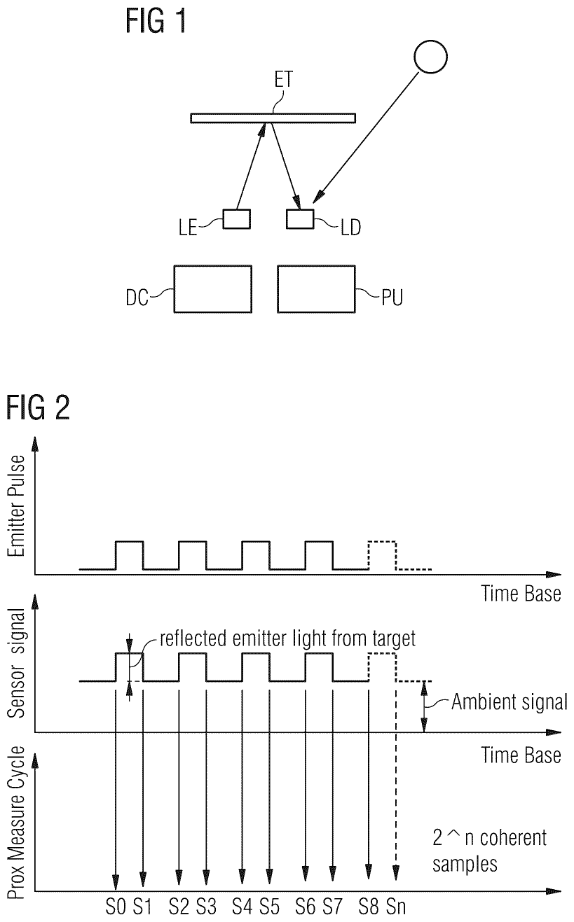

FIG. 1 shows an example embodiment proximity sensor system. The system comprises a light emitter LE, driver circuit DC, light detector LD and a processing unit PU. These components can be arranged in a common module with dedicated chambers for the light emitter and the light detector (not shown). These chambers have apertures in order to emit light away from the module and detect light which is reflected back into the module. For example, the module is molded. Furthermore, the electronic components can be integrated into a common integrated circuit. Typically, the light emitter is electronically connected and mounted to the common integrated circuit but may also be integrated into the common integrated circuit. The processing unit may be an external component, e.g. a processor of a host device into which the proximity sensor system is integrated or operated with. Alternatively, the processing unit is also integrated into the common integrated circuit. The module is not shown in the drawing for easier representation only.

The light emitter LE can be a light emitting diode (LED), or a semiconductor laser diode (e.g. a vertical cavity surface emitting laser, referred to as a VCSEL). The emitter may be configured to emit infra-red light. This can be advantageous compared to visible light because it is not visible to a user. Furthermore, more than a single light emitter can be implemented, e.g. of different emission wavelengths and/or as an array of emitters. The light emitter LE may be referred to simply as an emitter.

The light detector LD, or optical detector, can be a photodiode or avalanche photodiode, although other optical detectors may be used. The detector may be configured to detect infra-red light and generate respective sensor signals. Furthermore, more than a single light detector can be implemented, e.g. for different detection wavelengths (channels) and/or as an array of detectors. The light detector may be referred to simply as a detector.

The driver circuit DC drives the light emitter. For example, the driver circuit provides a programmable drive currents to the emitter. The drive currents can be applied for a defined period of time so that the light emitter emits a pulse of light with a defined pulse length and height. Furthermore, the driver circuit can be synchronized with the light detector to synchronize emission of light pulses with detection of reflected light pulses. Such synchronization may involve a time offset between emission and detection, which is set to account for a desired range of proximity targets, for example.

The processing unit PU has a number of functions related to operating the proximity sensor system. Basically, the processing unit receives the sensor signals from the detector LD and performs computational steps to conduct a signal processing thereof. The processing may involve some or all procedural steps of the proposed method of operating a proximity sensor system discussed in further detail below. The processing unit comprises a microcontroller, a computational unit, such as a processor or central processing unit, or the like. Furthermore, the processing unit can be synchronized with the driver circuit DC and/or issued synchronization signals to the driver circuit to synchronize emission and detection by means of the emitter and detector. Moreover, the processing unit can be configured to read out sensor signals.

Further components (not shown) of the proximity sensor system may include analog-to-digital converters, signal amplifiers, communications interfaces, logic engines as well as additional sensor, such as ambient light sensors, ALS.

FIG. 2 shows an example signal scheme of a proximity sensor system. One processing step, which is conducted by the processing unit PU, relates to transforming sensor signals received from the detector into the frequency domain. In other words, the processing unit is configured to convert sensor signal into a representation in the frequency domain.

In the drawing, the upper graph shows a series of emitter pulses emitted by the emitter as a function of time. The series of emitter pulses constitutes a periodic function in time. Depicted is a sampling window comprising five pulses. The graph in the middle shows a sensor signal detected by the detector as a function of time. The sensor signal resemble the emitter pulses as they are reflected at the external target ET. Furthermore, the sensor signal is offset by an amount due to ambient light. A constant offset is assumed only for easier representation. The bottom graph shows an example proximity measurement cycle, which indicates an example sampling of the sensor signal.

As a first step, the sensor signal is sampled in order to perform a frequency transform. In this example, a coherent sampling is conducted by means of the processing unit. Coherent sampling describes the sampling of a periodic signal (here: sensor signal), where an integer number of its cycles fit into a predefined sampling window. In this example, five pulses are shown in the sampling window. Accordingly, five cycles fit into the sampling window. The sensor signal in the sampling window is sampled, i.e. an integer number of signal values are recorded as samples S. In this example, 10 samples 0, . . . , n=9 are recorded, which, in turn, are representative of the sensor signal in the sampling window. As a lower minimum a number of samples are recorded that fulfill the Nyquist criterion. Preferably, 2ⁿ coherent samples are recorded. The series of samples forms a sampled sensor signal. The set of samples forms the domain for the frequency transform function or algorithm.

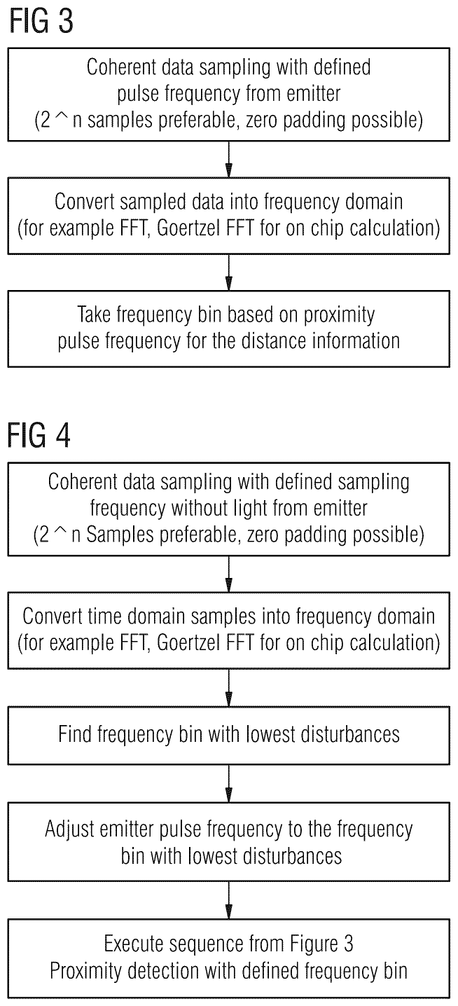

FIG. 3 shows an example flowchart of a method of operating a proximity sensor system. As discussed above, as a first step the sensor signal (e.g., in a sampling window) is sampled. For example, coherent data sampling is applied with a defined pulse frequency from the emitter. This way, 2ⁿ coherent samples are recorded (zero padding is possible). The samples form a series of samples, which is denoted the sampled sensor signal.

As a next step, the sampled sensor signal, which is a sequence representation of time, is converted into the frequency domain. The transform can be executed by means of the processing unit. For example, the processing unit is integrated into the common integrated and, thus, performs the conversion on-chip. Possible frequency transformations include Fast Fourier transform (FFT) or Goertzel FFT. The result is denoted converted sensor signal, and is a function of frequency rather than time. The converted sensor signal is a sequence representation of frequency. The sequence can be represented by binning the sequence samples into frequency bins, wherein each bin can be associated with a frequency or range of frequencies.

As a next step, the frequency bin is chosen, which corresponds to the proximity pulse frequency. In fact, each bin corresponds to a frequency or range of frequencies. In an ideal scenario with no ambient light, a single frequency bin is populated with samples. These samples correspond to the proximity pulse frequency and can, in a next step, be chosen to extract a proximity event and/or distance information of the external target.

In a scenario with DC ambient light, a number or even all frequency bins will be populated with samples. Again, the frequency bin which corresponds to the proximity pulse frequency can be chosen to extract a proximity event and/or distance information of the external target. Furthermore, if ambient light is constant, or assumed to be constant, during the sampling window, an offset can be subtracted from the frequency bins, so that only offset compensated samples remain. In a scenario with AC ambient light, i.e. ambient light contributions of different frequencies, a number but not all frequency bins will be populated with samples. Again, the frequency bin which corresponds to the proximity pulse frequency can be chosen to extract a proximity event and/or distance information of the external target. Thus, ambient light can be accounted for by selection of a frequency bin of interest. This frequency bin of interest, or the bin corresponding to the proximity pulse frequency, will typically have much lower, if not any, contribution of ambient light.

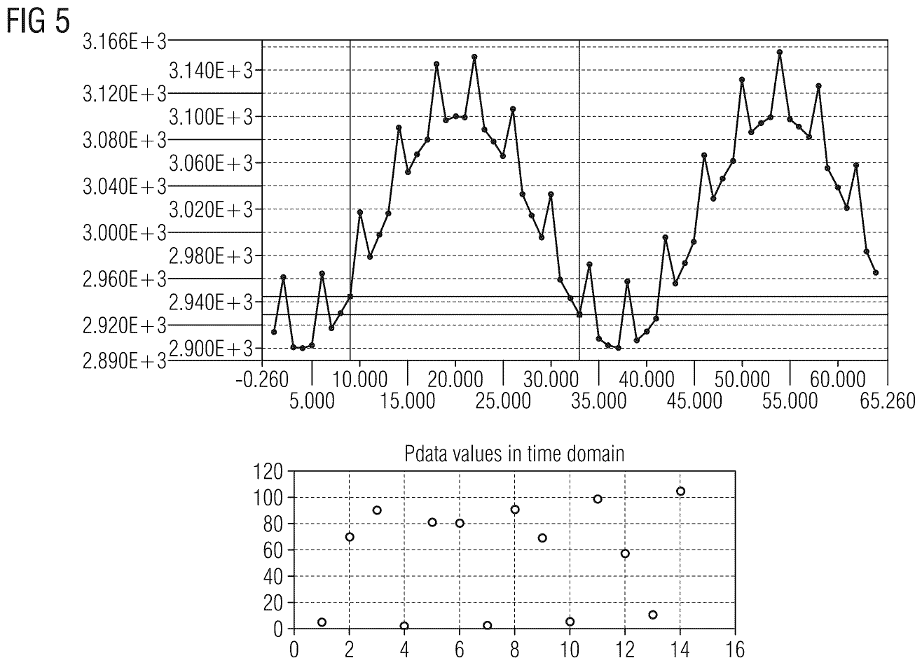

FIG. 4 shows an example flowchart of a method of operating a proximity sensor system. The flowchart shows a modification of the procedure discussed with respect to FIG. 3. In fact, the first steps including sampling and frequency transform are the same. However, the step of choosing the frequency bin is modified.

In said step, a frequency bin is determined which has the lowest disturbances. For example, this can be achieved by means of disturbance criterion. Typically, the frequency bins are populated to some degree, due to noise or a DC portion in ambient light, for example. Such an “idle” condition can be accounted for by a threshold value, which may be set to a predetermined value or be recorded during a calibration of the proximity sensor system. If a frequency bin is only populated to a degree below the threshold value, then it is considered low in disturbance. In practical terms this means that a frequency is not or only less affected by AC ambient light, for example. As a result of this analysis, which can be executed by the processing unit PU, a frequency bin is chosen, e.g. the one with the lowest disturbance.

As a next step, the proximity pulse frequency of the emitter is set to a frequency of the frequency bin, chosen in the previous step. For example, the proximity pulse frequency is set to the frequency of the frequency bin with lowest disturbance. From here, the procedure starts over again and the flowchart according to FIG. 3 is run through, with the chosen frequency bin corresponding to the proximity pulse frequency. This way, the analysis of a proximity event and/or distance information of the external target can be based on a frequency bin and proximity pulse frequency which is less affected by ambient light. The proximity pulse frequency can be adjusted or set by means of the processing unit, e.g. by issuing a control signal to the driver circuit DC.

FIG. 5 shows an example sensor signal with contribution of alternating ambient light. The graph on the left shows a sensor signal with a transient signal and 500 Hz sine wave. The series of emitter pulses (apparent as peaks) is superimposed with the sine wave, which simulated the effect of alternating (AC) ambient light. This example is intended as illustration or proof of principle rather than being representative of a common practical situation. The graph on the right shows an example of a common time domain sampling for the transient signal. In this example, taking an average value from the classical may still result in reasonable proximity results assuming the sampling rate is high enough and not affected from aliasing components.

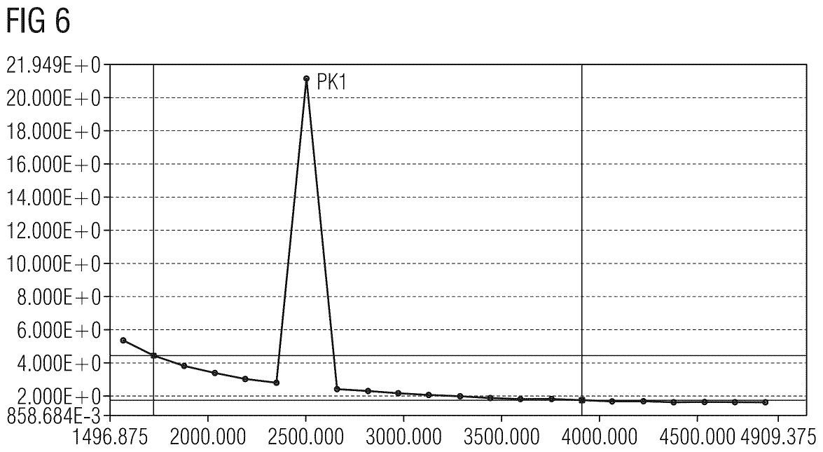

FIG. 6 shows an example sensor signal transformed into the frequency domain. The graph shows a converted sensor signal which is represented by binning the sequence samples into frequency bins. In this example, a frequency bin which corresponds to DC ambient light has been removed. The remaining peak PK1 corresponds to the proximity pulse frequency and can be used to detect a proximity event or extract distance information despite the presence of an AC ambient light component.

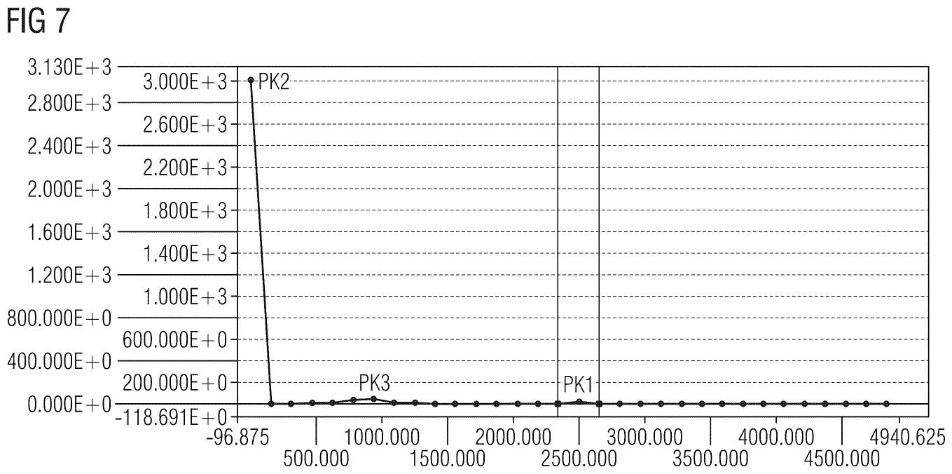

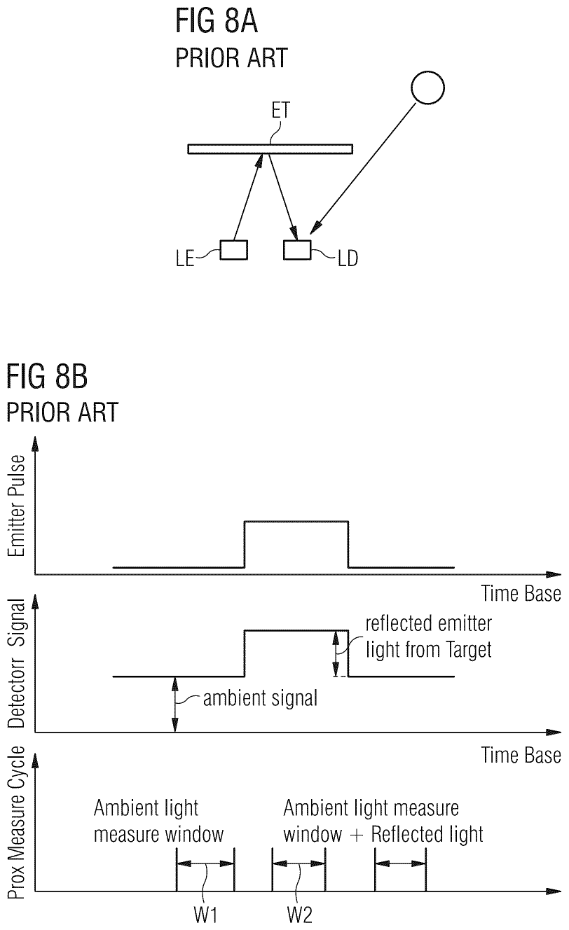

FIG. 7 shows an example sensor signal transformed into the frequency domain. The graph shows a converted sensor signal which is represented by binning the sequence samples into frequency bins. In this example, however, all frequency bins are depicted. In fact, the example corresponds to the example of FIG. 6. The additional peaks PK2, PK3 can be attributed to ambient light components. For example, bin 0 can be attributed to DC ambient light, which does not change over time, e.g. within the sampling window.

In a further embodiment (not shown) the proximity sensor system further comprises an ambient light sensor. The ambient light sensor, ALS, may reuse the same driving circuit and/or processing unit to operate. The ALS allows to conduct a parallel ambient light measurement. The ALS may be used to calibrate the DC component of the proximity sensing.

With the improved concept discussed above, multiple samples are captured. The sample array is post processed in the frequency domain and e.g. only the known frequency bin with the reflected light information is used for the distance measurement. Instead of using the distance information from existing proximity solutions, the frequency domain based method with a fast sampling proximity sensor gives additional to the distance information also frequency information from unwanted ambient light components which are not in the channel of interest and therefore much better suppressed in the distance information frequency bin. This offers higher immunity against ambient light disturbances and better noise suppression due to single frequency bin monitoring with the fast sampling proximity solution. Further advantages relate to proximity frequency hopping for noise suppression, proximity and ALS measurement in parallel and allows for low output power proximity for BOLED applications.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

A number of implementations have been described. Nevertheless, various modifications may be made without departing from the spirit and scope of the invention. Accordingly, other implementations are within the scope of the claims.

### REFERENCES

DC driver circuit
ET external target
LD light detector
LE light emitter
PK1 peak
PK2 peak
PK3 peak
PU processing unit
S sample

1. A proximity sensor system, comprising:
a light emitter and a driver circuit configured to drive the light emitter such that the light emitter emits a sequence of pulses towards an external target
a light detector operable to generate a time-dependent sensor signal which is indicative of light reflected off of the external target, and
a processing unit operable to convert the sensor signal to frequency-dependent converted sensor signal, wherein the converted sensor signal is a representation of the sensor signal in the frequency domain.

2. The system according to claim 1, wherein the processing unit is operable to sample the time-dependent sensor signal into a sampled sensor signal and convert the sampled sensor signal into the converted sensor signal.

3. The system according to claim 2, wherein the processing unit is operable to sample the time-dependent sensor signal by means of coherent sampling.

4. The system according to claim 1, wherein the processing unit is operable to convert the sensor signal by means of a Fast Fourier Transformation or a Goertzel Fast Fourier Transformation.

5. The system according to claim 1, wherein the processing unit is operable to:
group samples of the converted sensor signal into a number of frequency bins, and
determine a proximity event and/or distance information associated with the external target based on samples of one or more frequency bins.

6. The system according to claim 5, wherein the processing unit is operable to:
chose a frequency bin from the number of frequency bins, and
determine the proximity event and/or distance information associated with the external target based on samples from the chosen frequency bin only.

7. The system according to claim 5, wherein the processing unit is operable to:
determine a disturbance value of frequency bins, wherein the disturbance value is representative of samples associated to a frequency bin, respectively,
chose a frequency bin which meets a disturbance criterion,
adjust a proximity pulse frequency of the sequence of pulses to a value of the chosen frequency bin, and
adjust the driver circuit to drive the light emitter to emit the sequence of pulses towards an external target with pulses having the adjusted proximity pulse frequency.

8. The system according to claim 1, further comprising an ambient light sensor.

9. The system according to claim 1, wherein the processing unit, the light detector, the driver circuit and/or the light emitter are integrated into a common integrated circuit.

10. A method of operating a proximity sensor system, comprising the steps of:
using a light emitter, emitting a sequence of pulses towards an external target,
using a light detector, generating a time-dependent sensor signal, which is indicative of light reflected off of the external target, and
using a processing unit, converting the sensor signal into a representation in the frequency domain.

11. The method according to claim 10, wherein the time-dependent sensor signal is sampled into a sampled sensor signal, e.g. by coherent sampling, and the sampled sensor signal is converted into the converted sensor signal.

12. The method according to claim 10, wherein the sensor signal is converted by means of a Fast Fourier Transformation or a Goertzel Fast Fourier Transformation.

13. The method according to claim 10, wherein:
samples of the converted sensor signal are grouped into a number of frequency bins, and
a proximity event and/or distance information associated with the external target is determined based on samples of one or more frequency bins.

14. The method according to claim 13, wherein:
a frequency bin is chosen from the number of frequency bins, and
the proximity event and/or distance information associated with the external target is determined based on samples from the chosen frequency bin only.

15. The method according to claim 13, wherein:
a disturbance value of frequency bins is determined, wherein the disturbance value is representative of samples associated to a frequency bin, respectively,
a frequency bin is chosen which meets a disturbance criterion,
a proximity pulse frequency of the sequence of pulses to a value of the chosen frequency bin is adjusted, and
the light emitter is driven to emit the sequence of pulses towards an external target with pulses having the adjusted proximity pulse frequency.
